(19) United States
(12) Patent Application Publication
(10) Pub. No.: US 2011/0229746 A1
(43) Pub. Date: Sep. 22, 2011

(54) Battery for Electric Vehicle

(76) Inventors: Ralph KESSLER, Pfinztal (DE); Joerg Weigold, Karlsruhe (DE); Martin Meeh, Wiernsheim (DE)

(21) Appl. No.: 13/048,099

(22) Filed: Mar. 15, 2011

(30) Foreign Application Priority Data
Mar. 17, 2010 (DE) 10 2010 011 740.4

(51) Int. Cl. H01M 10/48

(52) U.S. Cl. 429/90

(57) ABSTRACT

The invention relates to a battery for an electric vehicle, comprising a plurality of cells (2) and a plurality of sensors (3, 4) for monitoring the state of cells (2). According to the invention, at least one communication unit (5) is provided to wirelessly transmit state information on one or more cells (2).

The invention relates to a battery for an electric vehicle, which comprises a plurality of cells.

The perpetual goal of the development of such batteries is to increase the number of charge and discharge cycles that the individual cells can withstand. Parameters of a battery such as the maximum storage capacity worsen due to ageing depending on how often the battery was charged and discharged. In order to detect damage in a timely manner, batteries of electric vehicles are therefore monitored using sensors that are connected to a control unit via a line. Typically in that case, at least one sensor which reports state data to a control device via a line is assigned to each battery cell. In this manner it is possible e.g. to detect local heating—which could cause a fire—in a timely manner and prevent a further temperature increase.

The problem addressed by the present invention is that of demonstrating a way to monitor the battery of an electric vehicle as efficiently as possible.

This problem is solved by a battery having the features indicated in claim 1. Advantageous developments of the invention are the subject matter of dependent claims.

In the case of a battery according to the invention a plurality of sensors is provided, each of which monitors the state of a cell or cell group. Such a cell group may be a cell block. Each sensor is connected to a communication unit which wirelessly transmits state information on the cell monitored by the sensor to a central unit during operation. Each sensor provides Information on a single cell or a part of the plurality of cells.

Wireless data transmission makes it possible to implement state monitoring of batteries in a cost-favorable manner since lines do not need to be installed between individual sensors and a central unit. The reliability of data transmission and the safety of the battery can be increased as a result. Namely, a battery according to the invention can be encapsulated entirely since the need to extend connecting lines between the individual sensors and a central unit to the outside is eliminated. A fully encapsulated battery is protected against harmful environmental influences. At the same time, a fluid-tight encapsulation of the battery protects the vehicle from the battery contents if damage occurs.

In the case of a battery according to the invention, at least one sensor is preferably assigned to each cell. Advantageously, the state of each individual cell can thus be monitored individually. For reasons of cost it can also be advantageous, however, to use one sensor to monitor a cell group. A battery can comprise a plurality of cell groups, each of which contains 2 to 5 or more cells, for example. Such a cell group can then be monitored using one or more of the sensors assigned to the group. Advantageously in particular temperature sensors can be used to monitor a cell group.

In the case of a battery according to the invention, a temperature sensor used to monitor the temperature of the cell is preferably assigned to each cell or cell group. A cell can overheat during charging in particular, which is dangerous. This can be detected easily using a temperature sensor.

As an alternative or in addition thereto, a voltage sensor can be assigned to each cell or group of cells. Overvoltages or undervoltages, which can damage the battery, can be detected in this manner. Preferably a temperature sensor and a voltage sensor are assigned to each cell of a battery according to the invention.

In the case of a battery according to the invention a separate communication unit can be provided for each cell group, cell, or even for each sensor. It is also possible, however, for the sensors of a plurality of cells to be connected to one common communication unit. In principle, a single communication unit suffices for the entire battery.

The state data transmitted according to the invention can be used advantageously, e.g. in the control of charging and discharging processes, in order to balance cell voltages.

According to an advantageous development of the invention, the communication unit transmits state information wirelessly, in particular as a high frequency signal. Carrier frequencies of at least 100 MHz, e.g. between 100 MHz and one GHz, are suitable in particular.

According to a further advantageous development of the invention, a characteristic cell identifier is assigned to each sensor, which is transmitted by the communication unit together with the state information ascertained by the sensor. Using the cell identifier, the central unit can unequivocally ascertain to which cell the applicable state information belongs. For example, the communication unit can transmit state information as a data telegram that contains a characteristic bit sequence that characterizes the cell. If a plurality of sensors is assigned to one cell, the particular sensor of the cell can be unequivocally identified by another part of the data telegram.

According to a further advantageous development of the invention, the communication unit contains an evaluation unit for evaluating state information that was measured. Such an evaluation unit can pre-evaluate state information that was measured, for example, and compress measured data delivered by the sensors, thereby reducing the volumes of data to be transmitted. One simple possibility e.g. is to calculate a mean of a plurality of values measured by a sensor, and to transmit it.

Preferably the evaluation unit compares state information that was measured with a setpoint value during operation and initiates a transmission operation if the measured state information is outside of a setpoint range, that is, deviates from the setpoint value by more than a specified tolerance value. In this manner the central unit can report a critical cell state at an early point in time. If measurements performed by a sensor indicate that a cell parameter, such as temperature or cell voltage, is no longer located in a setpoint range, this can be detected by the evaluation unit and reported to the central unit.

Preferably the communication unit contains a clock that triggers the transmission of state information at regular time intervals. For example, state information on the individual cells can be transmitted in succession at fixed time intervals. Advantageously, such a transmission at regular time intervals can be combined with an evaluation unit also triggering a transmission operation if measured state information is outside of a setpoint range. The clock of the communication unit can be implemented as a clock generator or counter which is required anyway for an ASIC or microprocessor.

Preferably the communication unit has various operating modes in which state information is transmitted at different time intervals. Transmission can therefore take place in shorter time intervals during battery charging and other critical operating states, for example. If the vehicle is at a standstill, i.e. the battery is unloaded, the time intervals between transmissions can be extended, or transmission activity can be halted altogether. Preferably, however, transmission activity can always be initiated by an evaluation unit when critical cell states occur.

According to a further advantageous development of the invention, the communication unit contains a transmitter as well as a receiver, and is triggered to transmit when a request signal is received. In this manner state information can be queried e.g. for diagnostic purposes. It is also possible for the central unit to trigger the communication unit, or the communication units of the battery, to transmit every time a vehicle is started, in order to obtain information on the state of the individual battery cells.

Preferably the communication unit contains a memory for storing state information and continously calculates, on the basis of state information, an ageing parameter that characterizes the operation-induced wear of a battery cell. Since the ageing of a cell depends decisively on the history of previous charge and discharge cycles, all data are available to the communication unit anyway for calculating or at least estimating the ageing of a cell according to a model. An ageing parameter calculated for each individual cell of a battery can always be transmitted with current state information. It is also possible, however, for the ageing parameter to be transmitted only using a special data telegram e.g. when requested by the central unit.

Data such as the entire period of use of a cell, the period of use in extreme states in which a parameter of a cell such as temperature or voltage is outside of a setpoint range, and/or the load history are stored in a memory of the communication unit. Preferably the communication unit can be triggered to transmit such data when a request signal is received.

Further details and advantages of the invention are explained using an embodiment, with reference to the attached drawing.

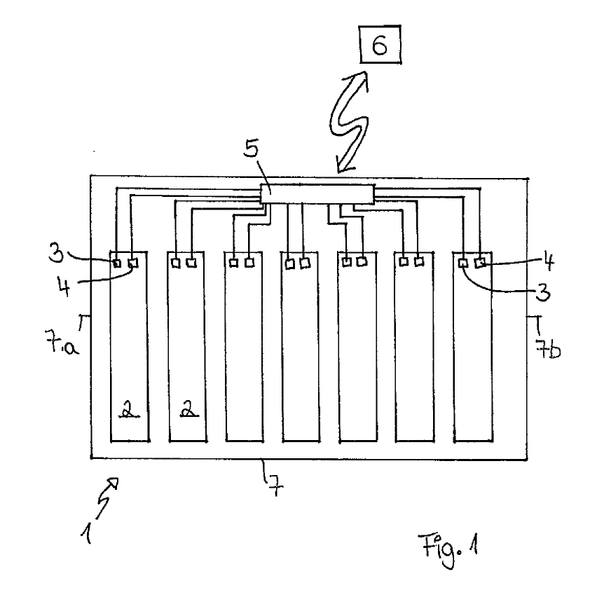

FIG. 1 shows a schematic depiction of an embodiment of a battery according to the invention.

Battery 1 shown in FIG. 1 contains a plurality of cells 2 which can be connected in series. Only one such cell block of series-connected cells 2 is present in the embodiment shown. In addition to said cell block, battery 1 can additionally comprise further cells 2 or cell blocks connected in parallel thereto.

Sensors 3, 4 for monitoring the state of particular cell 2 are assigned to individual cells 2. In the embodiment shown, a temperature sensor 3 and a sensor 4 for measuring cell voltage are assigned to each cell 2. Sensors 3, 4 are connected to a communication unit 5. Communication unit 5 transmits state information on cells 2 wirelessly to a central unit 6. Transmission occurs wirelessly as a high frequency signal at a frequency that can be between 100 MHz and one GHz, for example.

A characteristic cell identifier is assigned to each sensor 3, 4, which is transmitted by communication unit 5 together with the state information ascertained by sensor 3, 4. The cell identifier can be e.g. a characteristic bit sequence which is part of a data telegram with which communication unit 5 transmits data to central unit 6.

By monitoring individual cells 2, dangerous or potentially harmful operating states such as local overheating and overvoltage or undervoltage can be detected. Central unit 6 can then intervene in charge and discharge states in a controlling manner and prevent damage and/or generate a warning signal.

Each sensor 3, 4 provides information on only a part of the plurality of cells 2. In the embodiment shown, this part is a single cell 2, but each sensor may also provide information on a group of cells of a battery that has several groups of cells.

In the embodiment shown, communication unit 5 contains an evaluation unit for evaluating measured state information, e.g. an ASIC or microprocessor. The evaluation unit compares state information measured during operation with a setpoint value and triggers a transmission operation when the measured state information is outside of a setpoint range. In addition, the transmission of state information at regular intervals is triggered using a clock contained in communication unit 5.

Communication unit 5 contains a memory for storing state information. The evaluation unit continuously calculates, on the basis of state information, an ageing parameter that characterizes the operation-induced wear of individual battery cells. The ageing parameter can always be transmitted together with current state information. It is also possible for the ageing parameter to be transmitted using a data telegram intended especially for this purpose only in response to a special request.

Advantageously, operating data on cells 2, such as the entire period of use, the period of use outside of a setpoint range, in particular the period of use in extreme states, and the load history, can be stored in the memory of communication unit 5.

Communication unit 5 contains a receiver in addition to a transmitter. As such, communication unit 5 can be triggered to transmit by the receipt of a request signal from central unit 6. For example, communication unit 5 can be triggered in this manner to transmit an ageing parameter or other data on one or more cells 2. This is advantageous in particular when service is performed.

Battery 1 comprises a fluid-tight housing 7 in which individual cells 2 are encapsulated together with associated sensors 3, 4 and communication unit 5. Housing 7 has electrical connectors 7a, 7b on opposite ends.

Reference numerals
1 Battery
2 Cells
3, 4 Sensors
5 Communication unit
6 Central unit
7 Housing
7a, b Connectors

1. A battery for an electric vehicle, comprising a plurality of cells (2) and a plurality of sensors (3, 4) for monitoring the state of cells (2), characterized by at least one communication unit (5) for wirelessly transmitting state information on one or more cells (2).

2. The battery according to one or more of the preceding claims, characterized in that the battery (1) is encapsulated in a fluid-tight manner in a housing (7) which encloses the sensors (3, 4) and the at least one communication unit (5).

3. The battery according to one of the preceding claims, characterized in that a characteristic cell or cell group identifier is assigned to each sensor (3, 4), which is transmitted by the communication unit (5) together with state information ascertained by the sensor (3, 4).

4. The battery according to one of the preceding claims, characterized in that sensors (3, 4) of various cells or cell groups (2) are connected to a common communication unit (5).

5. The battery according to one of the preceding claims, characterized in that the communication unit (5) contains an evaluation unit for evaluating measured state information.

6. The battery according to claim 5, characterized in that the evaluation unit compares measured state information with a setpoint value during operation and triggers a transmission operation if the measured state information is outside of a setpoint range.

7. The battery according to claim 5 or 6, characterized in that the communication unit (5) comprises a memory for storing state information, the evaluation unit continuously calculating on the basis of state information an ageing parameter which characterizes the operation-induced wear of a battery cell (2).

8. The battery according to one of the preceding claims, characterized in that the communication unit (5) contains a receiver in addition to a transmitter and is triggered to transmit by the receipt of a request signal is received.

9. The battery according to one of the preceding claims, characterized in that the communication unit (5) contains a clock that triggers the transmission of state information at regular time intervals.

10. The battery according to one of the preceding claims, characterized in that the communication unit (5) transmits information as a radio signal having a carrier frequency between 100 MHz and 1 GHz.

11. The battery according to one of the preceding claims, characterized in that each sensor (3, 4) provides information on only a part of the plurality of cells (2).
